(19) United States
(12) Patent Application Publication
(10) Pub. No.: US 2007/0235906 A1
(43) Pub. Date: Oct. 11, 2007

(54) Method and Installation for the Production of Containers

(75) Inventor: Mickael Trouillet, Octeville-Sur-Mer (FR)

Correspondence Address: SUGHRUE MION, PLLC, 2100 PENNSYLVANIA AVENUE, N.W., SUITE 800, WASHINGTON, DC, 20037, US

(73) Assignee: SIDEL PARTICIPATIONS, Octeville sur Mer (FR)

(21) Appl. No.: 11/628,739

(22) PCT Filed: Jun. 7, 2005
(86) PCT No.: PCT/FR05/01399

§ 371 Date: Mar. 3, 2007

(30) Foreign Application Priority Data
Jun. 8, 2004 (FR) 0406188

(51) Int. Cl. B29C 49/64

(52) U.S. Cl. 264/528; 425/526

(57) ABSTRACT

A method of producing containers, including a forming step in which thermoplastic performs are used to form containers including a body and a base; and, subsequently, a cooling step in which the formed containers are cooled by projecting a jet onto the containers in a localized manner on a target area including the base thereof, the jet consisting of a mixture of a gas and an atomized liquid which are both at a relative pressure of less than approximately 1 bar. The invention also relates to an installation for the production of containers, which is adapted for the aforementioned method.

### FIELD OF THE INVENTION

The invention is concerned with the production of containers.

It relates more particularly to a method, and also to an installation, for the production of containers—particularly bottles—from thermoplastic preforms.

### BACKGROUND OF THE INVENTION

Such a method generally comprises a first step during which the preforms are heated as they file through a tunnel oven, followed by a second step, for the actual forming operation, during which the hot preforms are introduced into a blow molding or stretch blow molding device so as to be shaped into containers. The step of heating the preforms consists in bringing the thermo-plastic which constitutes them, or at the very least the temperature of the thermoplastic of their areas which are to be modified to obtain the containers, to a temperature exceeding the glass transition temperature, that is to say the softening temperature of said material. Thus, by way of example, when the containers to be produced are made of PET, in which case the transition temperature is around 80° C., the temperature to which the material is brought is around 120° C.-140° C.

On leaving the forming unit (that is to say, in practice, on leaving the blow molding or stretch blow molding device), the containers thus formed will be directed either toward a storage unit to await subsequent filling or directly toward a filling unit.

Whatever the case, when leaving the forming unit the containers may, at least locally in certain areas, remain at a temperature at which the thermoplastic has not recovered sufficient rigidity to allow the container to retain in the area in question the shape which it was given during the forming operation.

This situation particularly affects the base of the containers, which is generally thicker than their body and, therefore, tends to cool more slowly than the body and to remain momentarily soft on leaving the forming unit.

It consequently appears necessary, immediately after they have been formed, to cool the containers so as to fix the shape which they have been given. By way of example, PET containers, initially shaped at a temperature of greater than 80° C., must be returned to a temperature of less than 70° C. (preferably of around 60° C.).

It is known from French patent application FR-2 732 002, or from its American equivalent U.S. Pat. No. 5,996,322, to cool the containers by blowing fresh air (that is to say at a temperature equal to or less than the ambient temperature).

While this method is satisfactory for containers of simple shape, offering few obstacles to the flow of air or gas, its effectiveness nevertheless proves insufficient for containers having complex shapes, such as bottles with a petaloid base. In this instance, the heat transfer is not quick enough to prevent even minimal deformation of the base. This slow cooling progress negatively impacts the production rates.

It has also been proposed to cool the containers by means of a nebulizer which sprays the containers with a mist composed of air loaded with water droplets.

While such a solution does in fact make it possible to obtain quicker heat transfer than the simple air cooling described above, and therefore to carry out more effective cooling of the containers, it nevertheless has certain disadvantages.

Firstly, the mist proves difficult to direct, which means that the whole of the containers, and not just the unstable areas, are sprayed. This results in an insufficient efficiency of the cooling unit, which is particularly manifested by excess water consumption.

Secondly, the water which has not been vaporized on contact with the hot areas of the container tends to be deposited and to accumulate in areas from which it has to be drained.

### SUMMARY OF THE INVENTION

The invention is aimed particularly at overcoming the aforementioned disadvantages by providing a method and an installation for the production of containers whereby the containers can be cooled effectively in a simple and economic manner and whereby in fine the production rates can be increased.

To this end, the invention provides, according to a first aspect, a method for the production of containers, which comprises:
a forming step, starting from thermoplastic preforms, to form containers comprising a body and a base, followed by
a cooling step to cool the formed containers, in which method, in the cooling step, the formed containers are sprayed in a localized manner over a target area comprising the base of the containers with a jet composed of a mixture of a gas and of an atomized liquid, both at a relative pressure of less than approximately 1 bar.

According to another feature, the spraying is carried out over a target area of the containers.

The inventors have observed a high degree of cooling efficiency, particularly on account of the fineness of the particles which, on contact with the containers, tend to evaporate completely, this change of phase being accompanied by considerable heat transfer.

According to a second aspect, the invention provides an installation for the production of containers, which comprises:
a forming unit for shaping the containers by forming from thermoplastic preforms, and
a cooling unit for cooling the formed containers, which comprises:
   a pressurized-gas supply circuit,
   a pressurized-liquid supply circuit, and
   an atomizing nozzle to which said circuits are connected, this nozzle being designed to spray the formed containers with a jet composed of a mixture of gas and of atomized liquid.

### BRIEF DESCRIPTIONS OF THE DRAWINGS

Other objects and advantages of the invention will become apparent in the light of the description given below with reference to the appended drawings, in which:

FIG. 1 is a schematic top plan view showing an installation according to the invention;

FIG. 2 is a top plan view illustrating a detail of the installation of FIG. 1, corresponding to the inset II;

FIG. 3 is an elevation view in partial section, illustrating the cooling unit of the installation of FIG. 1;

FIG. 4 is a side elevation view in partial section illustrating the cooling unit of FIG. 3, as seen from a perpendicular angle of view;

FIG. 5 is a top plan view illustrating a mask of a cooling unit as represented in FIGS. 3 and 4;

FIG. 6 is a schematic diagram of the cooling unit of FIG. 3.

### DETAILED DESCRIPTION OF THE INVENTION

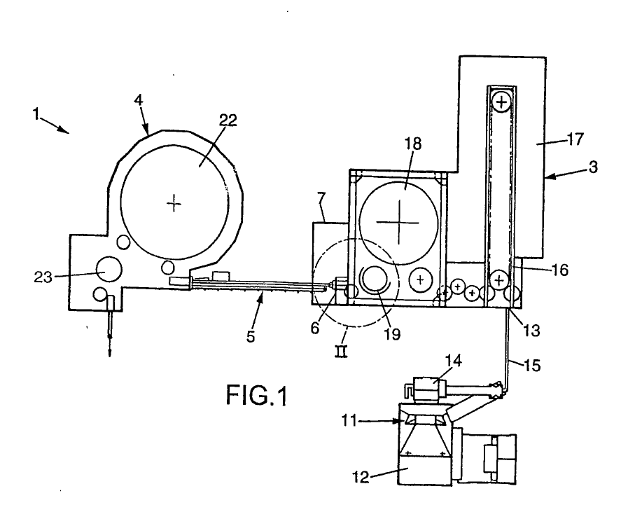

FIG. 1 shows an installation 1 for the production of containers 2 such as bottles, starting from thermoplastic preforms.

The installation 1 comprises a forming unit 3 to form the containers 2, a filling unit 4 to fill the containers 2, a conveyor 5 for conveying the formed containers 2 from the outlet 6 of the forming unit 3 toward the filling unit 4, and a cooling unit 7 placed at the outlet 6 of the forming unit 3 along the path of the containers 2 formed by the conveyor 5.

The containers 2 are made for example of polyethylene terephthalate (PET), polyethylene naphthalate (PEN), or any other suitable thermoplastic. Once formed, each container 2 has a body 8 (which may be cylindrical), a neck 9 and, at the opposite end to the neck 9, a base 10.

The installation 1 additionally comprises a supply unit 11 which delivers the preforms to the forming unit 3. The supply unit 11 comprises, for example, a hopper 12 in which the preforms, prefabricated by injection molding, are loosely piled, this hopper 12 being connected to the inlet 13 of the forming unit 3 via a sorter 14 which isolates and positions the preforms (which are cold, that is to say at ambient temperature) on a slide 15.

The preforms are subsequently mounted on a transfer chain 16 and then heated as they file through a tunnel oven 17 before being introduced hot into a blow molding or stretch blow molding device of the carousel type 18 having multiple molds (not shown).

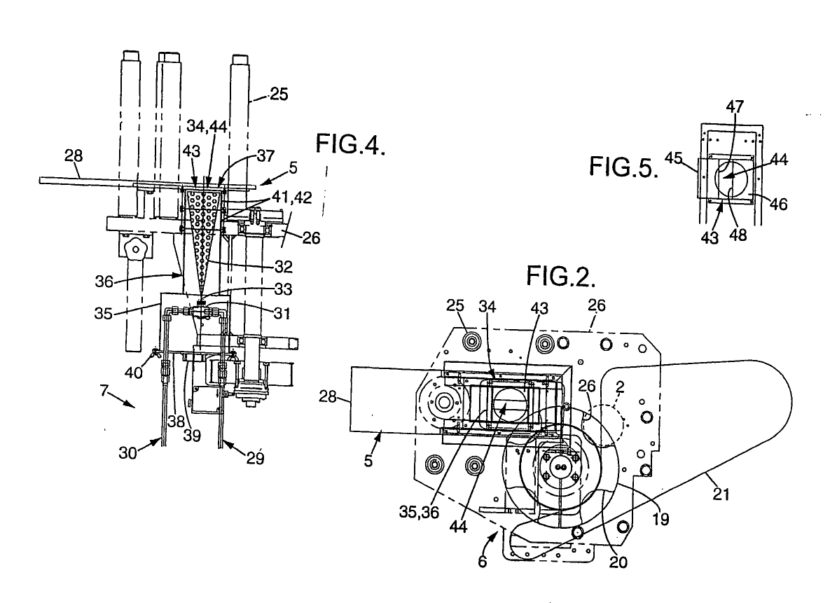

The containers 2 are then transferred, by means of a transfer wheel 19 provided with indentations 20 (visible in FIG. 2), from the molds of the blow molding device toward the conveyor 5 at the outlet 6 of the forming unit 3, where the containers 2 are cooled prior to being conveyed toward the filling unit 4.

The transfer wheel 19 is rotated by means of a transmission belt 21 connected to the carousel 18 in such a way as to synchronize the rotational speed of the wheel 19 with the tangential speed of the carousel 18.

In the filling unit 4, the containers 2 are arranged on a filling device 22 of the rotary drum type, from which, once filled, they are withdrawn and presented to a capping device 23. The containers 2 are then discharged toward a labeling unit (not shown) and then toward a packaging unit (not shown).

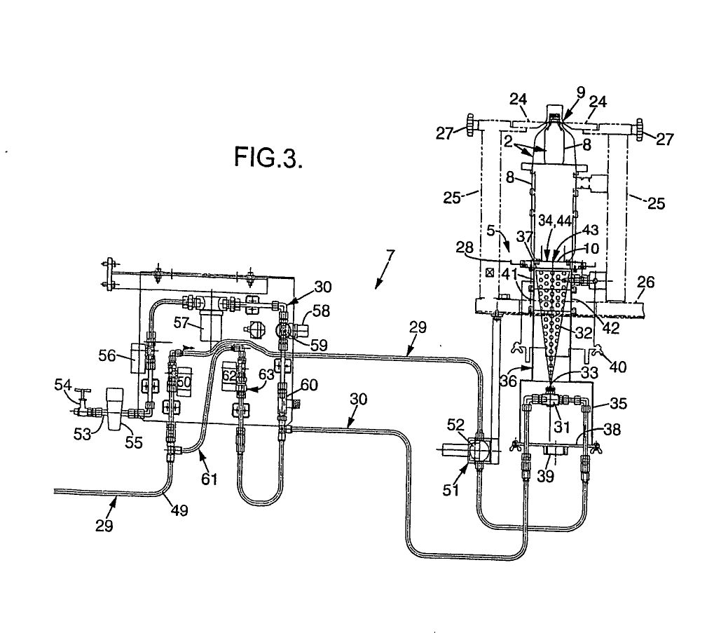

As is represented in FIG. 3, the conveyor comprises two rails 24 facing one another, from which the containers 2 are suspended by their neck 9 and on which they slide while pushing one another under the driving force of the transfer wheel 19.

The rails 24 are supported by cylindrical legs 25 which are themselves carried by a frame 26 which forms the bearing structure of the conveyor 5.

To make it possible to convey containers having necks 9 of different diameters, the rails 24 are mounted so that they can slide transversely on their supports, their distance apart being adjustable by means of hand wheels 27.

As is visible in FIG. 2, the conveyor 5 comprises, at the outlet 6 of the forming unit 3, a bottom plate 28 arranged below and facing the bottom 10 of the containers 2. Since the containers 2 are suspended from the rails 24, they do not rest on the bottom plate 28, the vertical positioning of which plate (that is to say its distance from the rails 24) being adjustable, depending on the size of the containers 2, so that the gap separating the bottom plate 28 from the base 10 of the containers 2 is as small as possible.

We will see in the following how this adjustment is performed.

The cooling unit 7 for its part comprises a pressurized-gas supply circuit 29, the gas typically being air, and a pressurized-liquid supply circuit 30, the liquid typically being water, both circuits being connected to a nozzle 31 arranged below the bottom plate 28 and at a certain distance therefrom, as is represented in FIGS. 3 and 4.

Thus, when it is supplied with air and water, the nozzle 31 generates a jet 32, composed of a mixture of air and of water in suspension, directed, outside the containers 2, toward their base 10, which here constitutes a target area which it is desired to cool from the outside, immediately after forming the containers 2.

The nozzle 31 has an orifice 33 directed toward an opening 34 made in the bottom plate 28 at the outlet 6 of the forming unit 3, the bases 10 of the containers 2 filing past perpendicularly to this opening.

To prevent sprays of liquid from reaching surrounding sensitive parts of the installation 1, the nozzle 31 is placed in a casing 35 which confines the jet 32 and allows condensed water to be recovered.

The casing 35 has a lateral wall 36 which is terminated by an upper end 37 by means of which the casing 35 is fastened to the bottom plate 28, the wall 36, of square cross section in the example shown, bordering the opening 34.

The casing 35 comprises, on the opposite side to its upper end 37, a receptacle 38 for recovering the condensed water which flows along the lateral wall 36. As is shown in FIG. 4, the receptacle 38 has an orifice 39 to which can be connected a pipe (not shown) for draining the water to outside the installation 1.

As is additionally visible in FIG. 4, the recovery receptacle 38, which closes the casing 35 at the bottom, is detachable to allow access to the nozzle 31. In practice, the receptacle 38 is mounted on the lateral wall 36 by means of wing nuts 40 which allow the receptacle 38 to be fitted and removed rapidly without the use of a tool.

In view of the installation 1 being adapted to the production of containers 2 of various sizes, means 41 are provided for adjusting the distance separating the nozzle 31 from the bases 10 of the containers 2, that is to say, in practice, for adjusting the distance separating the nozzle 31 from the bottom plate 28.

As illustrated in FIGS. 3 and 4, these means 41 take the form of at least one attached spacer which is mounted on the upper end 37 of the casing 35, being interposed between this casing and the bottom plate 28, which is thereby raised, this spacer having a lateral wall 42 which thus extends the lateral wall 36 of the casing 35.

This results in joint modularity of the cooling unit 7 and of the conveyor 5 depending on the size of the containers 2.

As is illustrated in FIG. 4, the nozzle 31 is designed to generate a jet 32 of conical shape. In order to optimally locate the jet 32 on the base 10 of the containers 2 outside these containers and as far as possible prevent water spraying beyond the bottom plate 28, the cooling unit 7 comprises a mask 43 which, mounted at the upper end 37 of the casing 35 across the opening 34, delimits a window 44 of adjustable width.

The mask 43 comprises two shutters 45, 46 arranged in a plane perpendicular to the axis of the nozzle 31 (that is to say to the general direction of the jet 32), these shutters having internal edges 47, 48 jointly delimiting the window 44. As is shown in FIG. 5, at least one of the shutters 45, 46 is slideably mounted to allow adjustment of the size (more precisely of the width) of the window 44 and thus regulate the cross section of the jet 32 at the outlet of the casing 35 depending particularly on the diameter of the base 10 of the containers 2.

The nozzle 31 is an atomizing nozzle: it is designed to atomize the water into fine droplets, that is to say of a diameter of less than 200 μm, whereas the conventional nebulizing nozzles generate large water droplets, that is to say of a diameter of greater than 400 μm.

The inventors have in fact observed that on contact with the hot plastic, that is to say at a temperature of greater than or equal to approximately 80° C., the atomized particles pass virtually immediately to the gaseous state. The transfer of heat accompanying this change of state from liquid to gas is what causes the cooling of the exposed parts of the containers 2 (in this instance the base 10).

Since the transfer of heat accompanying the change of state from liquid to gas is greater than that accompanying the simple heating of the water (as is the case during cooling by means of nebulization), cooling by means of spraying an atomized jet proves to be more efficient that nebulization.

There additionally result arrangements which precede the following advantages.

First, the water consumption is considerably reduced (the volume of a droplet having a diameter of 200 μm in fact represents one eighth of the volume of a droplet having a diameter of 400 μm).

Secondly, a significant reduction in soiling on the body 8 of the containers 2 is observed. Specifically, whereas large droplets which are deposited on the bodies 8 run down and leave behind traces which must then be removed, fine droplets do not have the opportunity to become deposited on the bodies 8, either because they have been vaporized on contact with the hot base 10 or because they have been stopped by the mask. The cleanliness of the containers is thus improved.

Thirdly, the vaporization of the fine droplets prevents contamination of the installation 1, that is to say water being sprayed onto the surrounding parts of the installation 1, which could in particular have harmful consequences in terms of electrical safety. Encasing the nozzle 31 also contributes to reducing this contamination.

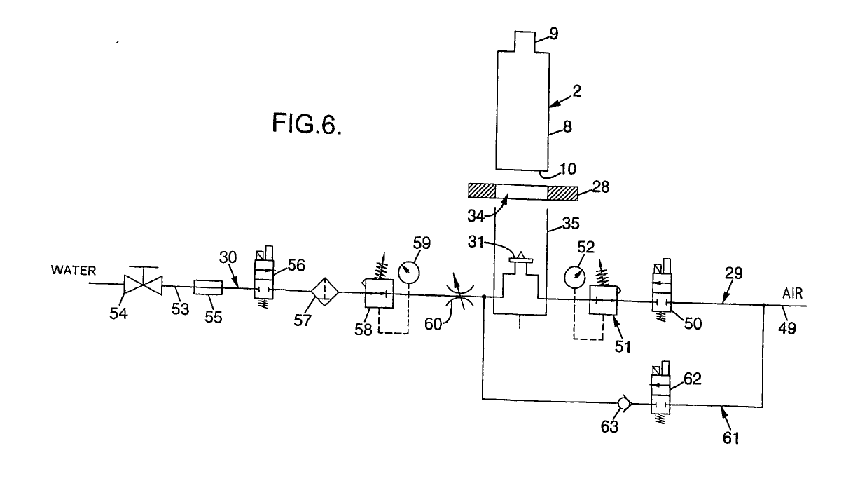

A description will now be given of the arrangement and the equipment of the pressurized-air and pressurized-water supply circuits 29, 30 with reference to FIGS. 3 and 6.

The air supply circuit 29 comprises an air feed line 49 connected to a general pressurized-air circuit (not shown; in industry, the relative air pressure in the general circuit is generally equal to 7 bar).

It should be noted that “relative” air pressure means the pressure difference between the measured air pressure and the atmospheric pressure.

The air feed line 49 is connected to a first solenoid valve 50 operated by a controller (not shown), the circuit 29 being closed when the installation 1 is at a standstill and being opened when it is operating.

Along the air supply circuit 29 is then placed, between the solenoid valve 50 and the nozzle 31, a pressure regulator 51 (in this instance a relief valve) designed so that the relative air pressure at its outlet is less than approximately 1 bar, preferably equal to approximately 0.7 bar. A manometer 52 (needle-type or digital) is attached to the regulator 51.

The water circuit 30 for its part comprises a water feed line 53 connected to the general water supply circuit (not shown), in this instance via a manually operated tap 54.

Between the tap 54 and the nozzle 31, the water encounters, along the circuit:
a first scale-inhibiting filter 55, of the electromagnetic type, intended to perform a first softening of the water by retaining the particles having a diameter of greater than 7 μm;
a second solenoid valve 56 operated by the afore-mentioned controller, the circuit 30 being closed when the installation 1 is at a standstill and being opened in contrast when this installation is operating;
a second scale-inhibiting filter 57 intended to perform a second softening of the water by retaining the particles having a diameter of greater than 5 μm;
a pressure regulator 58 to which a manometer 59 is attached, and
a flow limiter 60.

The pressure regulator 58 and the flow limiter 59 are respectively regulated so that the relative water pressure is less than 1 bar (preferably equal to approximately 0.7 bar) and the water throughput is less than 3 l/h.

In fact, the inventors have observed that, with these values, combined with a relative air pressure of less than 1 bar, the cooling unit has a maximum efficiency.

In addition, in order to purge the nozzle 31 on the water infeed side so as to prevent it from scaling up, particularly if the installation 1 is at a standstill for a prolonged period, the air supply circuit 29 is connected to the water supply circuit 30 by means of a bypass circuit 61 connected, on the one hand, to the air supply circuit 29 upstream of the first solenoid valve 50 and, on the other hand, to the water supply circuit 30 between the flow limiter 60 and the nozzle 31.

The bypass circuit 61 comprises, in succession, a third solenoid valve 62 operated by the controller when purging is judged necessary, and a nonreturn valve 63 intended to prevent water from rising into the air supply circuit 29.

The operation of the installation 1 is as follows.

The preforms are first introduced into the forming unit 3 by the supply unit 11. Within the forming unit 3, the containers 2 are formed from the preforms. The hot containers 2 are then transferred by the wheel 19, at the outlet 6 of the forming unit 3, toward the conveyor 5.

The containers 2 then pass across the opening 34, their base 10 being impinged by the jet 32 coming from the nozzle 31 and consequently cooled by the heat transfer accompanying the changeover from the liquid state of the atomized water particles to the gaseous state.

The invention cannot be limited to the foregoing description, with variants being conceivable.

Thus, although the nozzle 31 is supplied continuously, it is conceivable to program the controller in such a way as to generate the jet 32 intermittently as soon as a container 2 is presented across the window 44, in order to save water and prevent liquid being sprayed through the gap separating two successive containers 2.

Furthermore, although the cooling unit 7 is a fixed unit in the foregoing, it is conceivable to mount it on a sliding carriage accompanying the containers 2 over some of their journey along the conveyor 5 in order to cool the bases 10 further still.

It is also conceivable to place the nozzle 31 in line with the transfer wheel 19 or, more precisely, in line with the path followed by the indentations 20, in order for the containers 2 to be cooled while they are being transferred toward the conveyor 5, even before they leave the forming unit 3. Such an arrangement does not call for any specific modification of the actual structure of the cooling unit 7.

Moreover, although in the foregoing the area to be cooled (“target area”) comprises the base 10 of the containers 2, it is conceivable to select another target area depending on the shape of the containers. For example, this may concern areas on the body 8 which are provided with stiffeners, where the profile and/or the thickness of the wall vary locally.

In addition, it is of course possible to replace the air with any other inert gas (for example nitrogen), and the water with any other liquid, preferably a noncorrosive and nonpolluting liquid.

As for the mask 43, although embodied by means of sliding shutters 45, 46, it is conceivable to replace these shutters 45, 46 with a contractile diaphragm.

1. A method for the production of containers, which comprises:
a forming step, starting from preheated thermoplastic preforms, to form containers comprising a body and a base, followed by
a cooling step to cool the formed containers, wherein, in the cooling step, the formed containers are sprayed in a localized manner over a target area comprising the base of the containers with a jet composed of a mixture of a gas and of an atomized liquid, both at a relative pressure of less than approximately 1 bar.

2. The method as claimed in claim 1, in which the relative pressure of the gas is equal to approximately 0.7 bar.

3. The method as claimed in claim 1, in which the relative pressure of the liquid is equal to approximately 0.7 bar.

4. The method as claimed in claim 1, in which the gas is air.

5. The method as claimed in claim 1, in which the liquid is water.

6. An installation for the production of containers, which comprises:
a forming unit for shaping the containers by forming from thermoplastic preforms, and
a cooling unit for cooling the formed containers,
wherein the cooling unit comprises:
a pressurized-gas supply circuit,
a pressurized-liquid supply circuit, and
an atomizing nozzle to which said circuits are connected, this nozzle being designed to spray the formed containers with a jet composed of a mixture of gas and of atomized liquid, both at a relative pressure of less than approximately 1 bar.

7. The installation as claimed in claim 6, the gas supply circuit of which comprises a gas pressure regulator.

8. The installation as claimed in claim 6, the liquid supply circuit of which comprises a liquid pressure regulator.

9. The installation (1) as claimed in claim 6, the cooling unit of which comprises a casing in which the atomizing nozzle is placed, said casing having an upper end delimiting an opening toward which the nozzle is directed, this opening being placed perpendicularly to the path of the containers.

10. The installation as claimed in claim 9, which comprises means for adjusting the distance separating said opening from the nozzle.

11. The installation as claimed in claim 10, in which said adjustment means take the form of at least one spacer which can be mounted at the upper end of the casing.

12. The installation as claimed in claim 9, in which said casing comprises, at the opposite end to said opening, a receptacle for recovering the liquid.

13. The installation as claimed in claim 6, the cooling unit of which comprises a mask placed so as to face the nozzle along the path of the jet generated by this nozzle, said mask delimiting a window placed perpendicularly to the path of the containers.

14. The installation as claimed in claim 13, in which said mask comprises two shutters delimiting said window, at least one of the shutters being able to move in order to adjust the width of the window.

15. The installation as claimed in claim 9, the cooling unit of which comprises a mask placed so as to face the nozzle along the path of the jet generated by this nozzle, said mask delimiting a window placed perpendicularly to the path of the containers, and in which the mask is mounted at the upper end of said casing.
